(19) United States
(12) Patent Application Publication
(10) Pub. No.: US 2005/0015910 A1
(43) Pub. Date: Jan. 27, 2005

(54) Roller

(76) Inventors: Gary Jordan, Bromsgrove (GB); John Love, Shrawbury (GB); Stuart Hobbs, Bridgnorth (GB)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/877,797

(22) Filed: Jun. 25, 2004

(30) Foreign Application Priority Data
Jun. 28, 2003 (GB) GB 0315206.3

(51) Int. Cl. B05C 17/02

(52) U.S. Cl. 15/230.11; 492/19; 492/13

(57) ABSTRACT

A roller, particularly an applicator roller, comprising a handle connected to a flexible shaft at a first location and an applicator portion connected to the flexible shaft at a second location, spaced from the first location. The applicator portion preferably comprises an elongate portion, the elongate portion preferably extending substantially perpendicular to the flexible shaft. The shaft is preferably more flexible about an axis parallel to the elongate portion than an axis perpendicular to the elongate portion. Preferably the flexible shaft comprises a substantially oval cross-section. Alternatively the flexible shaft may comprise a substantially round cross-section.

The present invention relates to rollers, particularly but not exclusively applicator rollers.

Conventional applicator rollers are used to efficiently apply paint to a surface such as a wall. It is difficult to apply paint to certain areas, such as behind a radiator, which are difficult to reach.

According to the invention there is provided a roller comprising a handle connected to a flexible shaft at a first location and an applicator portion connected to the flexible shaft at a second location, spaced from the first location.

The applicator portion preferably comprises an elongate portion, the elongate portion preferably extending substantially perpendicular to the flexible shaft.

The shaft is preferably more flexible about an axis parallel to the elongate portion than an axis perpendicular to the elongate portion.

Preferably the shaft is at least twice as long as the handle. Preferably the length of the shaft is at least twice the length of the elongate portion of the applicator portion. Preferably the flexible shaft is at least 30 cm long and most preferably is about 37 cm long. The thickness of the flexible shaft in the direction of the axis perpendicular to the elongate portion is preferably not more than 10 mm, and is most preferably about 6 mm.

Preferably the flexible shaft comprises a substantially oval cross-section. Alternatively the flexible shaft may comprise a substantially round cross-section.

The handle is preferably connected to the shaft at or adjacent a first end of the shaft. The applicator portion is preferably connected to the shaft at a second, opposite end of the shaft.

The handle preferably comprises a grip portion, which may include finger accommodating formations and a thumb accommodating portion. The handle preferably comprises an aperture of corresponding cross-section to the shaft at the first location such that the shaft is receivably connected to the handle.

The applicator portion preferably comprises a frame portion, having the elongate portion thereon, and being adapted to receive an applicator sleeve, preferably on the elongate portion such that the applicator sleeve is perpendicular to the shaft in use. The applicator sleeve may comprise a channel such that it is slidably locatable on the elongate portion of the frame portion.

The applicator sleeve may be of a suitable material to apply gloss paint or emulsion paint, for example, to a wall. The applicator sleeve may be of a dense foam material, thus being suitable for applying pressure to wallpaper, for example, as it is being applied to a wall.

Alternatively, an applicator member may be provided integral with the applicator portion.

A long axis of the oval cross-section shaft may be aligned parallel to the elongate portion of the applicator portion, thereby providing strength to the shaft during normal use. Any other suitable cross-section of shaft may be utilised for this purpose, the shaft in cross-section, having an elongated axis parallel to said elongate direction.

The applicator portion preferably comprises a mounting aperture of corresponding cross-section to the shaft at the second location such that the shaft is receivably connected to the applicator portion.

The flexible shaft is preferably of a glass-fibre material.

An embodiment of the present invention will now be described by way of example only with reference to the accompanying drawings, in which

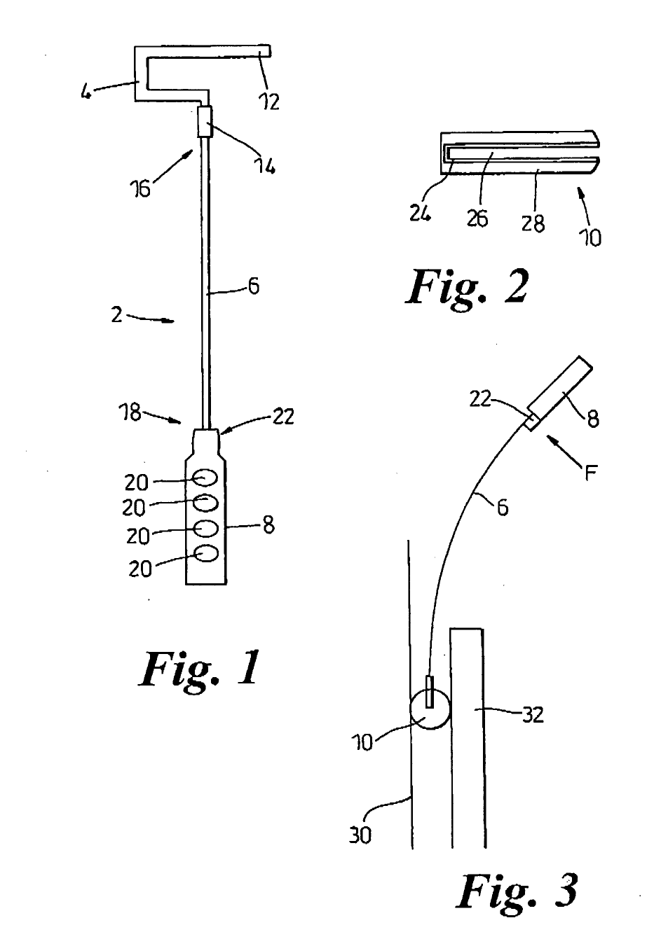

FIG. 1 shows a side view of a roller;

FIG. 2 shows a section view from a side through an applicator sleeve for use with the roller;

FIG. 3 is a schematic drawing of the roller in use;

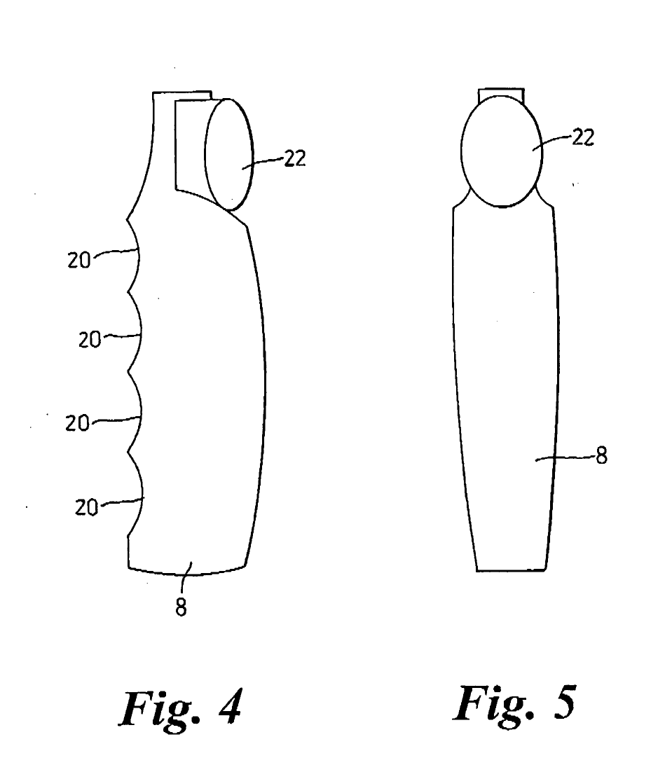

FIG. 4 shows a perspective view of a handle of the roller; and

FIG. 5 shows a side view of the handle of the roller.

Referring to FIG. 1, a roller 2 is shown comprising an applicator frame 4, a flexible shaft 6 and a handle 8. The applicator frame 4 is generally hook shaped and has a substantially circular cross-section. The applicator frame 4 comprises at one end an elongate roller supporting portion 12 extending in a first direction to define a roller axis. Towards the other end, the applicator frame 4 has a mounting part 14 of a hollow oval cross-section which is mounted on the shaft 6. The length of the shaft 6 is large in comparison with conventional rollers to allow sufficient flexibility in use.

The flexible shaft 6 is of a glass-fibre material and comprises a first end 16 and a second opposite end 18. The flexible shaft 6 is of a constant oval cross-section, corresponding to the internal cross-section of the mounting part 14. The first end 16 of the shaft 6 is receivable within the mounting part 14 of the applicator frame 4 and is secured in place by adhesive. The shaft 6 extends perpendicularly to the roller axis.

The oval section of the shaft 6 is orientated so that its greater diameter is parallel to the roller axis, and its lesser diameter is perpendicular to the roller axis. This means that it is more flexible in the direction perpendicular to the roller axis than in the direction parallel to the roller axis.

The handle 8 comprises a hollow oval cross-section having its longitudinal axis parallel to the shaft 6. The handle 8 has a rubber covering to provide grip. In addition, four finger accommodating formations 20 are provided on a side of the handle and a thumb accommodating formation 22 is provided on an opposite side of the handle 8 (as shown in FIG. 4). The handle 8 has an oval shaped aperture therein to receive the second end 18 of the shaft 6, which is secured in place by adhesive. The thumb accommodating formation 22 has a thumb engaging surface 22a facing in a direction perpendicular to both the shaft 6 and the roller axis.

Referring to FIG. 2, a cylindrical applicator sleeve 10 comprises a tubular plastic mounting portion 24 having a cylindrical channel 26 through it. The cylindrical channel 26 is profiled to be slidably and securely receivable on the elongate portion 12 of the applicator frame 4. An applicator material 28 suitable for applying emulsion paint to a surface covers the tubular plastic mounting portion 24. It will be realised that any suitable applicator material may be provided for different applications. For example an applicator material suitable for applying gloss paint to a surface may be provided or a dense foam material may be provided to apply pressure to a wallpapered surface for example.

In use the applicator sleeve 10 is mounted on the applicator frame 4 and the user grips the handle 8 using the finger accommodating formations 20 and thumb accommodating formation 22. Paint may be applied to the applicator material 28 in a conventional manner before applying to a wall 30 (as shown in FIG. 3). Referring to FIG. 3, it can be seen how paint may be easily applied to areas of the wall 30 which may be difficult to reach, for example if they are located behind a radiator 32. The applicator sleeve 10 is pressed against the wall 30 whilst the user may keep the handle 8 well away from the wall 30 by pressing on the thumb accommodating formation 22 in the direction of the arrow F to bend the flexible shaft 6. A conventional rigid roller would require the user to hold a rigid shaft of a conventional roller parallel to the wall 30 thereby restricting access to areas behind the radiator 32.

Various modifications may be made to the present invention without departing from its scope. For example a different type of handle may be provided such as a round cross-section handle. The flexible shaft may be of a different material. Any suitable form of securing the shaft to the handle and/or the applicator portion may be used.

1. A roller comprising a handle connected to a flexible shaft at a first location and an applicator portion connected to said flexible shaft at a second location, spaced from said first location.

2. The roller of claim 1 wherein said applicator portion comprises an elongate portion, said elongate portion extending substantially perpendicular to said flexible shaft.

3. The roller of claim 2, wherein said flexible shaft is more flexible about an axis parallel to said elongate portion than an axis perpendicular to said elongate portion.

4. The roller of claim 1 wherein said flexible shaft is at least twice as long as said handle.

5. The roller of claim 2 wherein the length of said flexible shaft is at least twice the length of said elongate portion.

6. The roller of claim 1 wherein said flexible shaft comprises one of a substantially oval cross-section and a substantially round cross-section.

7. The roller of claim 1 wherein said handle is connected to said shaft at or adjacent a first end of said flexible shaft and said applicator portion is connected to said shaft at a second, opposite end of said flexible shaft.

8. The roller of claim 1 wherein said handle comprises an aperture of corresponding cross-section to said flexible shaft at said first location such that said flexible shaft is receivably connected to said handle.

9. The roller of claim 1 wherein said applicator portion comprises a frame portion, being arranged to receive an applicator sleeve, such that said applicator sleeve is perpendicular to said flexible shaft in use.

10. The roller of claim 2 wherein said applicator portion comprises a frame portion, being arranged to receive an applicator sleeve, such that said applicator sleeve is perpendicular to said flexible shaft in use, wherein said frame portion has said elongate portion thereon and is arranged to receive said applicator sleeve on said elongate portion.

11. The roller of claim 9 wherein said applicator sleeve comprises a channel such that it is slidably locatable on said elongate portion of said frame portion.

12. The roller of claim 2 wherein said flexible shaft is of oval cross-section having a long axis aligned parallel to said elongate portion of the applicator portion.

13. The roller of claim 1 wherein said applicator portion comprises a mounting aperture of corresponding cross-section to said flexible shaft at said second location such that said flexible shaft is receivably connected to said applicator portion.

14. The roller of claim 1 wherein said flexible shaft is of a glass-fibre material.
